(19) United States
(12) Patent Application Publication
(10) Pub. No.: US 2018/0204009 A1
(43) Pub. Date: Jul. 19, 2018

(54) METHOD AND APPARATUS FOR CONTROLLING SECURE BOOT OF BOARD, AND METHOD AND APPARATUS FOR UPGRADING SOFTWARE PACKAGE

(71) Applicant: Huawei Technologies Co., Ltd., Shenzhen (CN)

(72) Inventor: Wei Xu, Shanghai (CN)

(21) Appl. No.: 15/922,708

(22) Filed: Mar. 15, 2018

Related U.S. Application Data
(63) Continuation of application No. PCT/CN2016/099115, filed on Sep. 14, 2016.

(30) Foreign Application Priority Data
Sep. 16, 2015 (CN) 201510589849.1

(51) Int. Cl. G06F 21/57; G06F 21/51; H04L 9/08; H04L 9/32; H04L 29/06; G06F 8/65; G06F 8/71

(52) U.S. Cl. CPC G06F 21/575; G06F 21/51; H04L 9/0825; G06F 8/71; H04L 63/12; G06F 8/65; H04L 9/3247

(57) ABSTRACT

A method for controlling secure boot of a board is disclosed, including: after the board is powered on, obtaining a re-signature of a software package to be loaded to the board, where the re-signature of the software package is obtained by using a board private key of the board to re-sign the software package, the re-signature is performed after an original signature of the software package passes a verification performed by using a software package public key of the software package, and the original signature is obtained by using a software package private key of the software package to sign the software package; using a board public key pairing with the board private key to check a re-signature of the software package; and booting the board after the re-signature passes the check. The method ensures other boards can securely boot when a key pair in a software package is leaked.

### CROSS-REFERENCE TO RELATED APPLICATIONS

This application is a continuation of International Application No. PCT/CN2016/099115, filed on Sep. 14, 2016, which claims priority to Chinese Patent Application No. 201510589849.1, filed on Sep. 16, 2015. The disclosures of the aforementioned applications are hereby incorporated by reference in their entireties.

### TECHNICAL FIELD

The present application relates to the field of communications technologies, and in particular, to a method and an apparatus for controlling secure boot of a board.

### BACKGROUND

As threats from hackers increase, operators pose a requirement on a trusted environment of telecommunications equipment, for example, a cryptographic manner is required for checking software when a multimode base station boots. If the check fails, the multimode base station cannot be connected to a network.

Generally, an equipment vendor of the telecommunications equipment pre-generates an asymmetrical key pair as a vendor key. The equipment vendor safekeeps a private key in the key pair, and signs a to-be-released software package by using the private key. A public key in the key pair is released along with the software package.

When a board in the telecommunications equipment securely boots, a check needs to be performed on software packages that are loaded level by level, and a check process is that the public key released along with the software package is used to check a signature of the software package. If the check succeeds, the software package is loaded, and the key pair is used to store the software package; or if the check fails, the software package is not loaded. In this way, a software package that is unauthorized or tampered with cannot be loaded.

When the board boots, and if the software package passes the check, it is ensured that the software package is released by the vendor. If all software packages used for the board boot can pass the check level by level, a chain of trust is constructed, and it is ensured that an initial software operating environment of the board is secure and reliable.

In the prior art, one software package may be used for multiple boards of a same model. Therefore, for different boards of a same model, it is difficult to release software packages that are signed by using different private keys. Because it is impossible to release a software package for each board, a same key pair needs to be stored. Therefore, the key pair released along with the software package is the key pair stored in the board. A situation in which multiple boards use a same key pair appears inevitably, and generally, all boards use a same key pair.

Therefore, once the key pair used by the equipment vendor for signing the software package is leaked, a batch of (or all) installed boards in the existing network are exposed to an attacker, and secure boot cannot be ensured.

### SUMMARY

To resolve the problem that in the prior art, boards cannot securely boot in batches because of leakage of a key pair, embodiments of the present disclosure provide a method for controlling secure boot of a board, so as to ensure that other boards still can securely boot when a key pair in a software package is leaked. The embodiments of the present disclosure further provide corresponding devices.

A first aspect of the present disclosure provides a method for controlling secure boot of a board, including:

after the board is powered on, obtaining a re-signature of a software package to be loaded to the board, where the re-signature of the software package is obtained by using a board private key of the board to re-sign the software package, the re-signature is performed after an original signature of the software package passes a verification performed by using a software package public key of the software package, and the original signature is obtained by using a software package private key of the software package to sign the software package;

using a board public key pairing with the board private key to check the re-signature of the software package; and

booting the board after the re-signature passes the check.

With reference to the first aspect, in a first possible implementation, before the obtaining a re-signature of a software package to be loaded to the board, the method further includes:

obtaining a to-be-updated software package;

using a software package public key of the to-be-updated software package to check an original signature of the to-be-updated software package in a secure world; and

after the original signature of the to-be-updated software package passes the check, re-signing the to-be-updated software package by using the board private key in the secure world.

With reference to the first possible implementation of the first aspect, in a second possible implementation, the method further includes:

replacing a corresponding software package of an earlier version and a re-signature corresponding to the software package of the earlier version with the to-be-updated software package and a re-signature of the to-be-updated software package, where the software package of the earlier version includes a software package public key of the earlier version.

A second aspect of the present disclosure provides a method for upgrading a software package, including:

obtaining a to-be-updated software package of a board;

using a software package public key of the to-be-updated software package to check an original signature of the to-be-updated software package in a secure world; and

after the original signature of the to-be-updated software package passes the check, re-signing the to-be-updated software package by using a board private key of the board in the secure world, where the re-signature is used to check security of the software package when the board boots.

With reference to the second aspect, in a first possible implementation, the method further includes:

replacing a corresponding software package of an earlier version and a re-signature corresponding to the software package of the earlier version with the to-be-updated software package and a re-signature of the to-be-updated software package, where the software package of the earlier version includes a software package public key of the earlier version.

A third aspect of the present disclosure provides an apparatus for controlling secure boot of a board, including:

an obtaining module, configured to: after the board is powered on, obtain a re-signature of a software package to be loaded to the board, where the re-signature of the software package is obtained by using a board private key of the board to re-sign the software package, the re-signature is performed after an original signature of the software package passes a verification performed by using a software package public key of the software package, and the original signature is obtained by using a software package private key of the software package to sign the software package;

a check module, configured to use a board public key pairing with the board private key to check the re-signature of the software package obtained by the obtaining module; and

a board boot module, configured to boot the board after the re-signature passes the check performed by the check module.

With reference to the third aspect, in a first possible implementation, the apparatus further includes a signing module and a storage module, where
the obtaining module is further configured to obtain a to-be-updated software package;

the check module is further configured to use a software package public key of the to-be-updated software package obtained by the obtaining module to check an original signature of the to-be-updated software package in a secure world; and

the signing module is configured to: after the original signature of the to-be-updated software package passes the check performed by the check module, re-sign the to-be-updated software package by using the board private key in the secure world.

With reference to the first possible implementation of the third aspect, in a second possible implementation, the apparatus further includes a replacement module, where

the replacement module is configured to replace a corresponding software package of an earlier version and a re-signature corresponding to the software package of the earlier version with the to-be-updated software package and a re-signature of the to-be-updated software package obtained by the signing module, where the software package of the earlier version includes a software package public key of the earlier version.

A fourth aspect of the present disclosure provides an apparatus for upgrading a software package, including:

an obtaining module, configured to obtain a to-be-updated software package of a board;

a check module, configured to use a software package public key of the to-be-updated software package obtained by the obtaining module to check an original signature of the to-be-updated software package in a secure world; and

a signing module, configured to: after the original signature of the to-be-updated software package passes the check performed by the check module, re-sign the to-be-updated software package by using a board private key of the board in the secure world, where the re-signature is used to check security of the software package when the board boots.

With reference to the fourth aspect, in a first possible implementation, the apparatus further includes a replacement module, where

the replacement module is configured to replace a corresponding software package of an earlier version and a re-signature corresponding to the software package of the earlier version with the to-be-updated software package and a re-signature of the to-be-updated software package obtained by the signing module, where the software package of the earlier version includes a software package public key of the earlier version.

According to the method for controlling secure boot of aboard provided in the embodiments of the present disclosure, one set of boards include two key pairs: a board public key, a board private key, a software package public key, and a software package private key. For a signature of a software package that passes a check, the board private key is further used to re-sign the software package, thereby improving storage security of the software package. In addition, a board private key and a board public key of each board are different from board private keys and board public keys of other boards. Therefore, even if a board public key and a board private key of a board are cracked by a hacker, booting of other boards is not affected.

### BRIEF DESCRIPTION OF DRAWINGS

To describe the technical solutions in the embodiments of the present disclosure more clearly, the following briefly describes the accompanying drawings required for describing the embodiments. Apparently, the accompanying drawings in the following description show merely some embodiments of the present disclosure, and a person skilled in the art may still derive other drawings from these accompanying drawings without creative efforts.

FIG. 1 is a schematic diagram of a secure world and a normal world of a central processing unit;

FIG. 2 is schematic diagram of a process of re-signing a software package according to an embodiment of the present disclosure;

FIG. 3 is a schematic diagram of an embodiment of a method for controlling secure boot of a board according to an embodiment of the present disclosure;

FIG. 4 is a schematic diagram of an embodiment of a method for upgrading a software package according to an embodiment of the present disclosure;

FIG. 5 is a schematic diagram of an embodiment of an apparatus for controlling secure boot of a board according to an embodiment of the present disclosure;

FIG. 6 is a schematic diagram of another embodiment of an apparatus for controlling secure boot of a board according to an embodiment of the present disclosure;

FIG. 7 is a schematic diagram of another embodiment of an apparatus for controlling secure boot of a board according to an embodiment of the present disclosure;

FIG. 8 is a schematic diagram of an embodiment of an apparatus for upgrading a software package according to an embodiment of the present disclosure;

FIG. 9 is a schematic diagram of another embodiment of an apparatus for upgrading a software package according to an embodiment of the present disclosure;

FIG. 10 is a schematic diagram of another embodiment of an apparatus for controlling secure boot of a board according to an embodiment of the present disclosure; and

FIG. 11 is a schematic diagram of another embodiment of an apparatus for upgrading a software package according to an embodiment of the present disclosure.

### DESCRIPTION OF EMBODIMENTS

Embodiments of the present disclosure provide a method for controlling secure boot of a board, a method for upgrading a software package, and at the same time, a method for revoking a leaked software package public key. The methods provided in the embodiments of the present disclosure can ensure that other boards still can securely boot when a key pair in a software package is leaked. The embodiments of the present disclosure further provide corresponding apparatuses. Details are separately illustrated in the following.

The following describes the technical solutions in the embodiments of the present disclosure with reference to the accompanying drawings in the embodiments of the present disclosure. Apparently, the described embodiments are merely some but not all of the embodiments of the present disclosure. All other embodiments obtained by a person skilled in the art based on the embodiments of the present disclosure without creative efforts shall fall within the protection scope of the present disclosure.

For ease of understanding, aboard is first described briefly.

A board is hardware in communications equipment. The board according to an embodiment of the present disclosure generates a different asymmetrical key pair for each board during a production phase. The asymmetrical key pair is referred to as a board key pair in this embodiment of the present disclosure, and includes a board private key and a board public key. It needs to be ensured that the board key pair cannot be tampered with, and the board private key cannot be read from the outside. Generally, in a security module of a chip, after being generated, the board private key is directly programmed in the security module (for example, eFuse) of the chip, and cannot be tampered with or directly accessed, and can be accessed only by using a hardware security engine. The board public key may be stored on a flash memory. However, a hash value of the board public key is stored in the eFuse for preventing from being tampered with.

A corresponding software package needs to be loaded when the board boots, and after the software package is successfully loaded, the board completes a boot process. However, the software package is applicable to a batch of boards. When the software package is released, there is a corresponding software package key pair, including a software package public key and software package private key. The software package private key is preserved by a vendor, and the software package public key is released along with the software package.

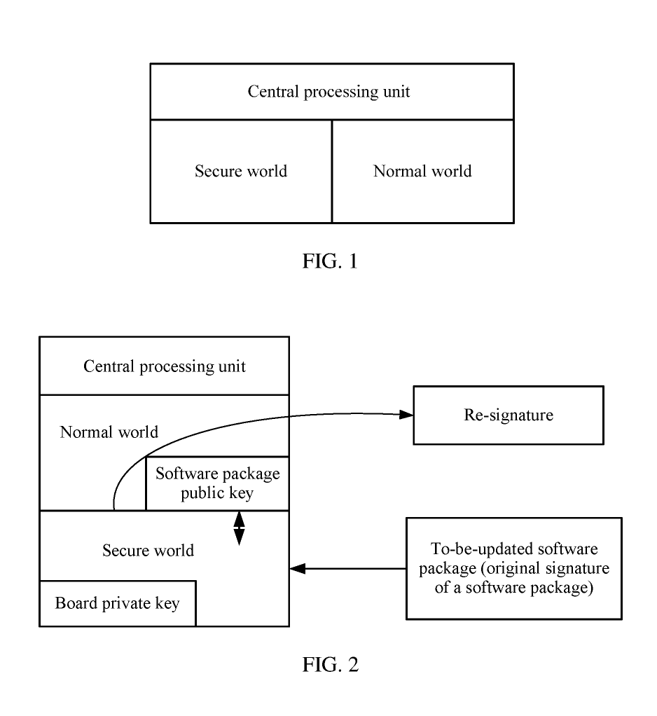

A TrustZone technology physically distributes a central processing unit (CPU) as a secure world (secure world) and a normal world (Normal World). As shown in FIG. 1, security-related behavior such as encryption and decryption are allowed to be run in the physically isolated secure world. An operating system (OS) or application (APP) of the normal world cannot access an address of the secure world.

For software, the secure world and the normal world are separated, and different software can run in the secure world and the normal world. Software of the normal world cannot directly learn an address in the secure world, and can only request the secure world to execute a specific function in a specific manner (for example, by using an interrupt).

After the board is installed on the communications equipment, and when the board is powered on to boot, a CPU on the board checks, by using the board public key of the board, software packages required for board bootup level by level starting from BootROM secure boot code (BSBC). To-be-checked software packages may be selected according to a security requirement. Generally, during the boot, a software package that needs to be loaded to an internal memory needs to be checked. For example, the software packages that need to be checked when the board boots may include a BootROM, a patch, an OS, an APP, or the like. If a signature of a software package matches a signature of the software package on the board, the boot continues; or if a signature of a software package does not match a signature of the software package on the board, the board stops loading and booting. It should be noted that all signatures according to this embodiment of the present disclosure refer to digital signatures.

If the software package public key is hard-coded in code, after the software package passes the check, the software package public key is also proved to be valid and secure.

Software that resides in the secure world is also a part of the software package, and the software that resides in the secure world is checked by using a signature during the boot. After passing the check, code of the software that resides in the secure world is loaded to and resides in the secure world for running, and is responsible for completing a security-related function.

Actually, in this embodiment of the present disclosure, the signature checked during the board boot is a re-signature completed by using the board private key in the secure world. When the software package is updated, the vendor releases a new software package, that is, a to-be-updated software package. The new software package carries the software package public key. After obtaining the to-be-updated software package, the CPU places the to-be-updated software package in the secure world, and uses the to-be-updated software package public key to check a signature of the to-be-updated software package in the secure world. The signature may be understood as an original signature of the software package. The original signature is obtained by using the software package private key of software package to sign the software package. After the original signature passes the check, the board private key of the board is used to re-sign the to-be-updated software package in the secure world, and a re-signature of the to-be-updated software package and the to-be-updated software package are associated and stored, so as to obtain an updated software package. If the software package public key is hard-coded in code, after the software package passes the check, the software package public key is also proved to be valid and secure. Because the software package public key is in the software package, after the software package is re-signed, the software package public key is also protected by the re-signature.

In this embodiment of the present disclosure, a software operating environment of the secure world is physically separated from that of the normal world. Therefore, it is very difficult for a hacker to attack and crack the software operating environment of the secure world. Therefore, checking and re-signing the software package in the secure world are secure and reliable.

A process of the software package from the original signature to the re-signature can be understood by referring to FIG. 2.

The to-be-updated software package uses the software package public key to check the original signature of the to-be-updated software package in the secure world, and, after the original signature of the to-be-updated software package passes the check, uses the board private key to perform a re-signing operation on the to-be-updated software package to obtain the re-signature of the to-be-updated software package.

After the board is powered on, re-signatures of software packages are checked. After re-signatures of all to-be-loaded software packages pass the check when board boots, it indicates that the board successfully boots.

In the prior art, the signature of the software package is used for both software package upgrading and secure boot. Consequently, all boards need to use a same key during the secure boot. However, in this embodiment of the present disclosure, the two phases, that is, the software package upgrading and the board boot, are separated. Each board re-signs a downloaded software package, so that the software package stored by each board has a different key and signature, and a risk of leakage is reduced. In addition, even if the board public key and the board private key of the board are cracked by a hacker, security of other boards is not affected.

In addition, in this embodiment of the present disclosure, the check and the re-signing are completed at a time in a trusted environment of the secure world, and a problem of a signature authentication is resolved by using the original signature of the software package.

The present disclosure is not limited to a specific communications system, and is for a board that supports a secure boot feature, and affects a scenario of booting a trusted board and a scenario of software updating.

In addition, it should be noted that, in this embodiment of the present disclosure, two additional solutions can be further used to resolve a problem about updating when the asymmetrical key pair is leaked.

Solution 1:

1. This strategy also requires that an asymmetrical board key pair is preset in a trusted environment in the CPU, but only the board public key needs to be programmed in the trusted environment in the CPU. Because a re-signature is not involved, the board private key does not need to be stored in the CPU, but is kept by an equipment vendor. Asymmetrical board key pairs for all boards are the same.

2. The public key used for checking the software package is released along with a BootROM.

3. After the software package is released, the BootROM is signed and released by using the board private key.

4. When the board boots, the CPU uses the board public key to check that a signature of the BootROM is correct, and the BootROM uses the software package public key to check that a signature of the software package is correct.

5. When the software package public key needs to be updated, the updating is completed by upgrading the BootROM.

In this solution of the present disclosure, the board key pair and the software package key pair are distinguished from each other, and therefore, updating of a software package key is supported. However, because no re-signing process is performed, a same board key pair is required for all boards, otherwise a digital signature required for upgrading the BootROM cannot be released.

Solution 2:

Compared with solution 1, in solution 2, multiple board key pairs are embedded in a trusted environment of the board, and these board key pairs are the same for all boards.

When a first board key pair is leaked, the first board key pair is invalidated by using an upgrading or revocation command. During a reboot, because the first board key pair is invalidated, a signature of the BootROM signed by using a private key in the first group of board key pair cannot pass the check, while digital signatures of key pairs that are not revoked are valid. This avoids a condition that all board keys need to be immediately updated when a board key pair is leaked.

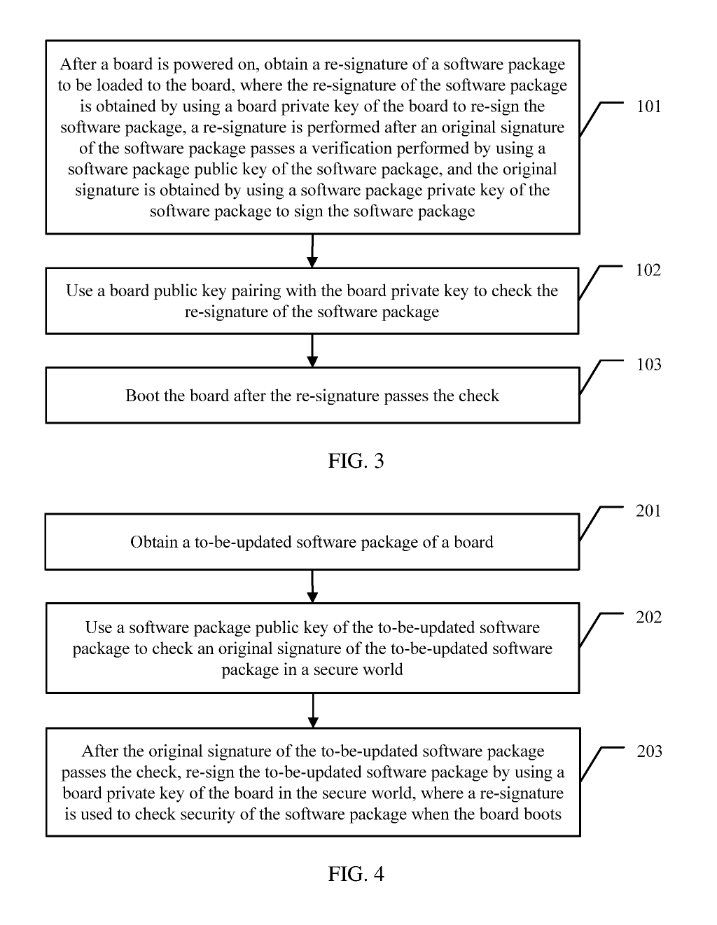

Referring to FIG. 3, an embodiment of a method for controlling secure boot of a board according to an embodiment of the present disclosure includes:

101. After a board is powered on, obtain a re-signature of a software package to be loaded to the board, where the re-signature of the software package is obtained by using a board private key of the board to re-sign the software package, the re-signature is performed after an original signature of the software package passes a verification performed by using a software package public key of the software package, and the original signature is obtained by using a software package private key of the software package to sign the software package.

102. Use board public key pairing with the board private key to check the re-signature of the software package.

103. Boot the board after the re-signature passes the check.

According to the method for controlling secure boot of aboard provided in this embodiment of the present disclosure, one set of boards include two key pairs: a board public key, a board private key, a software package public key, and a software package private key. For a signature of a software package that passes a check, the board private key is further used to re-sign the software package, thereby improving storage security of the software package. In addition, a board private key and a board public key of each board are different from board private keys and board public keys of other boards. Therefore, even if a board public key and a board private key of a board are cracked by a hacker, booting of other boards is not affected.

Optionally, on the basis of the foregoing embodiment corresponding to FIG. 3, in a first optional embodiment of the method for controlling secure boot of a board provided in this embodiment of the present disclosure, before the obtaining a re-signature of a software package to be loaded to the board, the method further includes:

obtaining a to-be-updated software package;

using a software package public key of the to-be-updated software package to check an original signature of the to-be-updated software package in a secure world; and

after the original signature of the to-be-updated software package passes the check, re-signing the to-be-updated software package by using the board private key in the secure world.

Optionally, on the basis of the foregoing first optional embodiment, in the first optional embodiment of the method for controlling secure boot of a board provided in this embodiment of the present disclosure, after storing the to-be-updated software package and a corresponding re-signature of the to-be-updated software package, the method may further include:

replacing a corresponding software package of an earlier version and a re-signature corresponding to the software package of the earlier version with the to-be-updated software package and the re-signature of the to-be-updated software package, where the software package of the earlier version includes a software package public key of the earlier version.

In this embodiment of the present disclosure, the software package public key is included in the software package. Therefore, in a secure world environment, when one software package public key is leaked, the software package can be revoked by updating the software package, and the software package public key is updated at the same time.

The embodiment or the optional embodiment corresponding to FIG. 3 may be understood by referring to the previously described software updating and board booting solutions. Details are not described herein again.

Referring to FIG. 4, an embodiment of a method for upgrading a software package according to an embodiment of the present disclosure includes:

201. Obtain a to-be-updated software package of a board.

202. Use a software package public key of the to-be-updated software package to check an original signature of the to-be-updated software package in a secure world.

203. After the original signature of the to-be-updated software package passes the check, re-sign the to-be-updated software package by using a board private key of the board in the secure world, where the re-signature is used to check security of the software package when the board boots.

According to the method for upgrading a software package provided in this embodiment of the present disclosure, one set of boards include two key pairs: a board public key, a board private key, a software package public key, and a software package private key. For a signature of a software package that passes a check, the board private key is further used to re-sign the software package, thereby improving storage security of the software package. In addition, a board private key and a board public key of each board are different from board private keys and board public keys of other boards. Therefore, even if a board public key and a board private key of a board are cracked by a hacker, booting of other boards is not affected.

Optionally, on the basis of the foregoing embodiment corresponding to FIG. 4, in an optional embodiment of the method for upgrading a software package provided in this embodiment of the present disclosure, after storing the to-be-updated software package and a corresponding re-signature of the to-be-updated software package, the method may further include:

replacing a corresponding software package of an earlier version and a re-signature corresponding to the software package of the earlier version with the to-be-updated software package and the re-signature of the to-be-updated software package, where the software package of the earlier version includes a software package public key of the earlier version.

In this embodiment of the present disclosure, the software package public key is included in the software package. Therefore, in a secure world environment, when one software package public key is leaked, the software package can be revoked by updating the software package, and the software package public key is updated at the same time.

The embodiment or the optional embodiment corresponding to FIG. 4 may be understood by referring to the previously described software updating solutions. Details are not described herein again.

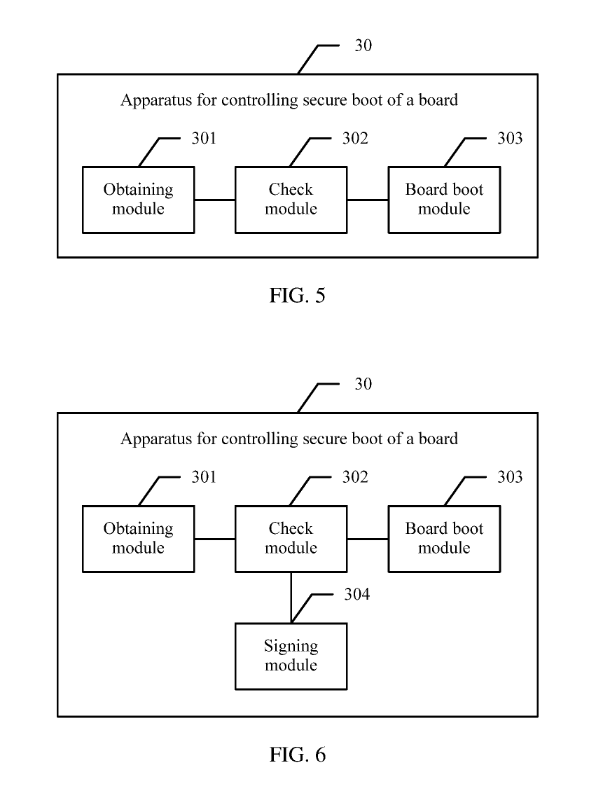

Referring to FIG. 5, an embodiment of an apparatus 30 for controlling secure boot of a board according to an embodiment of the present disclosure includes:

an obtaining module 301, configured to: after the board is powered on, obtain a re-signature of a software package to be loaded to the board, where the re-signature of the software package is obtained by using a board private key of the board to re-sign the software package, the re-signature is performed after an original signature of the software package passes a verification performed by using a software package public key of the software package, and the original signature is obtained by using a software package private key of the software package to sign the software package;

a check module 302, configured to use a board public key pairing with the board private key to check the re-signature of the software package obtained by the obtaining module 301;

a board boot module 303, configured to boot the board after the re-signature passes the check performed by the check module 302.

In this embodiment of the present disclosure, after the board is powered on, the obtaining module 301 obtains the re-signature of the software package to be loaded to the board, where the re-signature of the software package is obtained by using the board private key of the board to re-sign the software package, the re-signature is performed after the original signature of the software package passes the verification performed by using the software package public key of the software package, and the original signature is obtained by using the software package private key of the software package to sign the software package; the check module 302 uses the board public key pairing with the board private key to check the re-signature of the software package obtained by the obtaining module 301; and the board boot module 303 boots the board after the re-signature passes the check performed by the check module 302. Compared with that all key pairs of a batch of boards are the same in the prior art, the apparatus for controlling secure boot of a board provided in this embodiment of the present disclosure includes two key pairs: a board public key, a board private key, a software package public key, and a software package private key. For a signature of a software package that passes a check, the board private key is further used to re-sign the software package, thereby improving storage security of the software package. In addition, a board private key and a board public key of each board are different from board private keys and board public keys of other boards. Therefore, even if a board public key and a board private key of a board are cracked by a hacker, booting of other boards is not affected.

Optionally, on the basis of the foregoing embodiment corresponding to FIG. 5, referring to FIG. 6, in a first optional embodiment of the apparatus 30 for controlling secure boot of a board according to this embodiment of the present disclosure, the apparatus 30 further includes a signing module 304.

The obtaining module 301 is further configured to obtain a to-be-updated software package.

The check module 302 is further configured to use a software package public key of the to-be-updated software package obtained by the obtaining module 301 to check an original signature of the to-be-updated software package in a secure world.

The signing module 304 is configured to: after the original signature of the to-be-updated software package passes the check performed by the check module 302, re-sign the to-be-updated software package by using the board private key in the secure world.

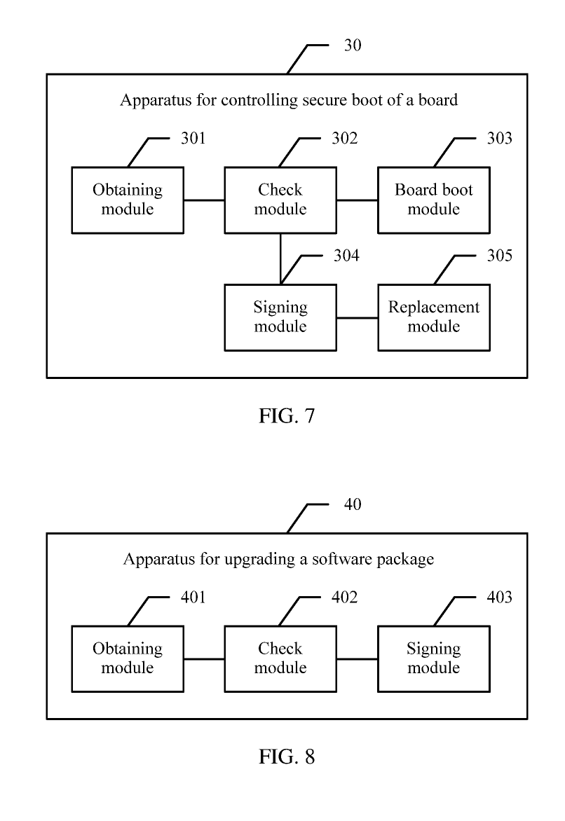

Optionally, on the basis of the foregoing embodiment corresponding to FIG. 6, referring to FIG. 7, in a second optional embodiment of the apparatus 30 for controlling secure boot of a board according to this embodiment of the present disclosure, the apparatus 30 further includes a replacement module 305.

The replacement module 305 is configured to replace a corresponding software package of an earlier version and a re-signature corresponding to the software package of the earlier version with the to-be-updated software package and a re-signature of the to-be-updated software package obtained by the signing module 304, where the software package of the earlier version includes a software package public key of the earlier version.

The embodiments or the optional embodiments corresponding to FIG. 5 to FIG. 7 may be understood by referring to related descriptions before FIG. 3, and the partial embodiments or optional embodiments in FIG. 3. Details are not described herein again.

Referring to FIG. 8, an embodiment of an apparatus 40 for upgrading a software package according to an embodiment of the present disclosure includes:

an obtaining module 401, configured to obtain a to-be-updated software package of a board;

a check module 402, configured to use a software package public key of the to-be-updated software package obtained by the obtaining module 401 to check an original signature of the to-be-updated software package in a secure world; and

a signing module 403, configured to: after the original signature of the to-be-updated software package passes the check performed by the check module 402, re-sign the to-be-updated software package by using a board private key of the board in the secure world, where the re-signature is used to check security of the software package when the board boots.

In this embodiment of the present disclosure, the obtaining module 401 obtains the to-be-updated software package of the board; the check module 402 uses the software package public key of the to-be-updated software package obtained by the obtaining module 401 to check the original signature of the to-be-updated software package in a secure world; the signing module 403 re-signs the to-be-updated software package by using the board private key of the board in the secure world after the original signature of the to-be-updated software package passes the check performed by the check module 402, where the re-signature is used to check security of the software package when the board boots. Compared with that all key pairs of a batch of boards are the same in the prior art, the apparatus for upgrading a software package provided in this embodiment of the present disclosure includes two key pairs: a board public key, a board private key, a software package public key, and a software package private key. For a signature of a software package that passes a check, the board private key is further used to re-sign the software package, thereby improving storage security of the software package. In addition, a board private key and a board public key of each board are different from board private keys and board public keys of other boards. Therefore, even if a board public key and a board private key of a board are cracked by a hacker, booting of other boards is not affected.

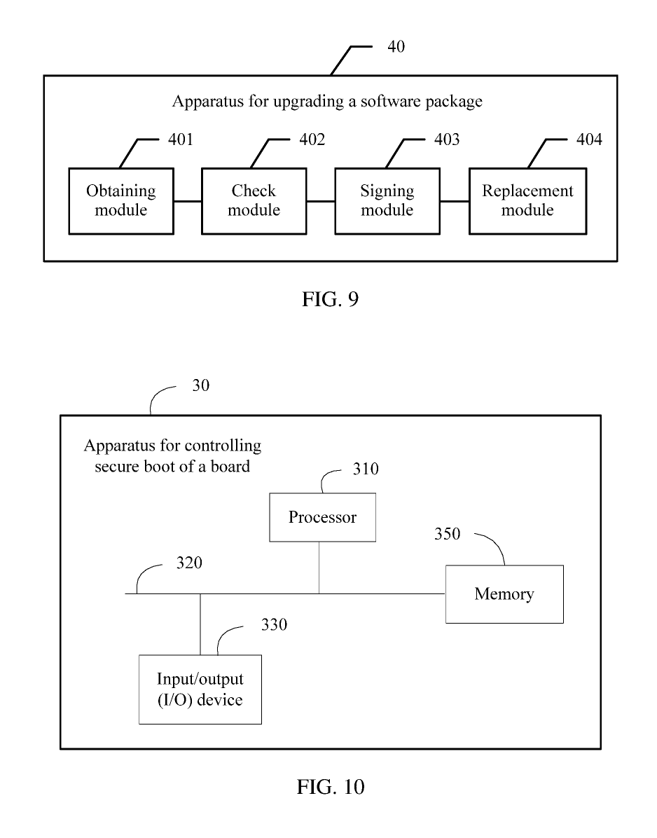

Optionally, on the basis of the foregoing embodiment corresponding to FIG. 8, referring to FIG. 9, in an optional embodiment of the apparatus 40 for upgrading a software package according to this embodiment of the present disclosure, the apparatus 40 includes a replacement module 404.

The replacement module 404 is configured to replace a corresponding software package of an earlier version and a re-signature corresponding to the software package of the earlier version with the to-be-updated software package and a re-signature of the to-be-updated software package obtained by the signing module, where the software package of the earlier version includes a software package public key of the earlier version.

The embodiments or the optional embodiments corresponding to FIG. 8 and FIG. 9 may be understood by referring to related descriptions about software updating before FIG. 3, and the embodiments or optional embodiments in FIG. 4. Details are not described herein again.

FIG. 10 is a schematic structural diagram of an apparatus 30 for controlling secure boot of a board according to an embodiment of the present disclosure. The apparatus 30 for controlling secure boot of a board includes a processor 310, a memory 350, and an input/output I/O device 330. The memory 350 may include a read-only memory and a random access memory, and provides an operating instruction and data for the processor 310. A part of the memory 350 may further include a nonvolatile random access memory (NVRAM).

In some implementations, the memory 350 stores the following elements: an executable module or a data structure, or a subset thereof, or an extended set thereof.

In this embodiment of the present disclosure, by calling the operating instruction stored in the memory 350 (the operating instruction may be stored in an operating system), the processor 310 performs the following operations:

after the board is powered on, obtaining a re-signature of a software package to be loaded to the board, where the re-signature of the software package is obtained by using a board private key of the board to re-sign the software package, the re-signature is performed after an original signature of the software package passes a verification performed by using a software package public key of the software package, and the original signature is obtained by using a software package private key of the software package to sign the software package;

using a board public key pairing with the board private key to check the re-signature of the software package; and

booting the board after the re-signature passes the check.

According to the apparatus for controlling secure boot of a board provided in this embodiment of the present disclosure, one set of boards include two key pairs: a board public key, a board private key, a software package public key, and a software package private key. For a signature of a software package that passes a check, the board private key is further used to re-sign the software package, thereby improving storage security of the software package. In addition, a board private key and a board public key of each board are different from board private keys and board public keys of other boards. Therefore, even if a board public key and a board private key of a board are cracked by a hacker, controlling, by another processor 310, an operation of the apparatus 30 for controlling secure boot of a board is not affected. The processor 310 may be further referred to as a CPU (Central Processing Unit, central processing unit). The memory 350 may include a read-only memory and a random access memory, and provides an instruction and data for the processor 310. Apart of the memory 350 may further include a nonvolatile random access memory (NVRAM). In specific application, all components of the apparatus 30 for controlling secure boot of a board are coupled together by using a bus system 320. In addition to a data bus, the bus system 320 may further include a power bus, a control bus, a status signal bus, and the like. However, for clarity of description, various buses are marked as the bus system 320 in the figure.

The method disclosed in the foregoing embodiment of the present disclosure may be applied to the processor 310, or be implemented by the processor 310. The processor 310 may be an integrated circuit chip and has a signal processing capability. In an implementation process, the steps in the foregoing method may be completed by means of an integrated logic circuit of hardware in the processor 310 or an instruction in a form of software. The processor 310 may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor 310 may implement or perform the methods, steps, and logical block diagrams that are disclosed in the embodiments of the present disclosure. The general-purpose processor may be a microprocessor or this processor may be any normal processor, or the like. The steps of the methods disclosed with reference to the embodiments of the present disclosure may be directly executed and accomplished by means of a hardware decoding processor, or may be executed and accomplished by using a combination of hardware and software modules in the decoding processor. The software module may be located in a mature storage medium in the field, such as a random access memory, a flash memory, a read-only memory, a programmable read-only memory, an electrically erasable programmable memory, or a register. The storage medium is located in the memory 350. The processor 310 reads information in the memory 350, and completes the steps in the foregoing methods in combination with hardware of the processor.

Optionally, the processor 310 is further configured to:

obtain a to-be-updated software package;

use a software package public key of the to-be-updated software package to check an original signature of the to-be-updated software package in a secure world; and

after the original signature of the to-be-updated software package passes the check, re-sign the to-be-updated software package by using the board private key in the secure world.

Optionally, the processor 310 is further configured to: replace a corresponding software package of an earlier version and a re-signature corresponding to the software package of the earlier version with the to-be-updated software package and a re-signature of the to-be-updated software package, where the software package of the earlier version includes a software package public key of the earlier version.

The embodiment or the optional embodiment corresponding to FIG. 10 may be understood by referring to related descriptions before FIG. 3, and the embodiments or optional embodiments in FIG. 3 and FIG. 5 to FIG. 7. Details are not described herein again.

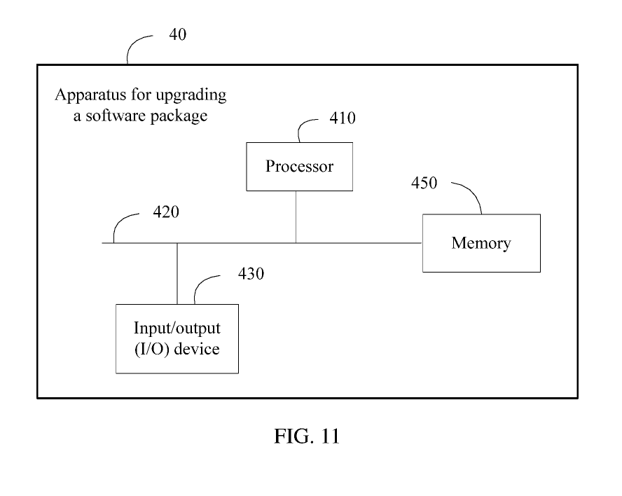

FIG. 11 is a schematic structural diagram of an apparatus 40 for upgrading a software package according to an embodiment of the present disclosure. The apparatus 40 for upgrading a software package includes a processor 410, a memory 450, and an input/output I/O device 430. The memory 450 may include a read-only memory and a random access memory, and provides an operating instruction and data for the processor 410. A part of the memory 450 may further include a nonvolatile random access memory (NVRAM).

In some implementations, the memory 450 stores the following elements: an executable module or a data structure, or a subset thereof, or an extended set thereof.

In this embodiment of the present disclosure, by calling the operating instruction stored in the memory 450 (the operating instruction may be stored in an operating system), the processor 410 performs the following operations:

obtaining a to-be-updated software package of a board;

using a software package public key of the to-be-updated software package to check an original signature of the to-be-updated software package in a secure world; and

after the original signature of the to-be-updated software package passes the check, re-signing the to-be-updated software package by using a board private key of the board in the secure world, where the re-signature is used to check security of the software package when the board boots.

According to the apparatus for controlling secure boot of a board provided in this embodiment of the present disclosure, one set of boards include two key pairs: a board public key, a board private key, a software package public key, and a software package private key. For a signature of a software package that passes a check, the board private key is further used to re-sign the software package, thereby improving storage security of the software package. In addition, a board private key and a board public key of each board are different from board private keys and board public keys of other boards. Therefore, even if a board public key and a board private key of aboard are cracked by a hacker, other boards are not affected.

The processor 410 controls an operation of the apparatus 40 for upgrading a software package. The processor 410 may be further referred to as a CPU (Central Processing Unit, central processing unit). The memory 450 may include a read-only memory and a random access memory, and provides an instruction and data for the processor 410. Apart of the memory 450 may further include a nonvolatile random access memory (NVRAM). In specific application, all components of the apparatus 40 for upgrading a software package are coupled together by using a bus system 420. In addition to a data bus, the bus system 420 may further include a power bus, a control bus, a status signal bus, and the like. However, for clarity of description, various buses are marked as the bus system 420 in the figure.

The method disclosed in the foregoing embodiment of the present disclosure may be applied to the processor 410, or be implemented by the processor 410. The processor 410 may be an integrated circuit chip and has a signal processing capability. In an implementation process, steps in the foregoing methods can be implemented by using a hardware integrated logical circuit in the processor 410, or by using instructions in a form of software. The processor 410 may be a general-purpose processor, a digital signal processor (DSP), an application-specific integrated circuit (ASIC), a field programmable gate array (FPGA) or another programmable logic device, a discrete gate or a transistor logic device, or a discrete hardware component. The processor 410 may implement or perform the methods, steps, and logical block diagrams that are disclosed in the embodiments of the present disclosure. The general-purpose processor may be a microprocessor or this processor may be any normal processor, or the like. The steps of the methods disclosed with reference to the embodiments of the present disclosure may be directly executed and accomplished by means of a hardware decoding processor, or may be executed and accomplished by using a combination of hardware and software modules in the decoding processor. The software module may be located in a mature storage medium in the field, such as a random access memory, a flash memory, a read-only memory, a programmable read-only memory, an electrically erasable programmable memory, or a register. The storage medium is located in the memory 450. The processor 410 reads information in the memory 450, and completes the steps in the foregoing methods in combination with hardware of the processor.

Optionally, the processor 410 is further configured to:

replace a corresponding software package of an earlier version and a re-signature corresponding to the software package of the earlier version with the to-be-updated software package and a re-signature of the to-be-updated software package, where the software package of the earlier version includes a software package public key of the earlier version.

The embodiment or the optional embodiment corresponding to FIG. 11 may be understood by referring to related descriptions before FIG. 3, and the embodiments or optional embodiments in FIG. 4, FIG. 8, and FIG. 9. Details are not described herein again.

A person of ordinary skill in the art may understand that all or a part of the steps of the methods in the embodiments may be implemented by a program instructing relevant hardware. The program may be stored in a computer readable storage medium. The storage medium may include: a ROM, a RAM, a magnetic disk, or an optical disc.

The method and the apparatus for controlling secure boot of a board and the method and the apparatus for upgrading a software package provided in the embodiments of the present disclosure are described in detail above. The principle and implementation of the present disclosure are described herein by using specific examples. The description about the foregoing embodiments is merely used to help understand the method and core ideas of the present disclosure. In addition, a person of ordinary skill in the art can make modifications to the present disclosure in terms of the specific implementations and application scopes according to the ideas of the present disclosure. Therefore, the content of specification shall not be construed as a limit to the present disclosure.

What is claimed is:

1. A method for controlling secure boot of a board, the method comprising:
after the board is powered on, obtaining a re-signature of a software package to be loaded to the board, wherein the re-signature of the software package is obtained by using a board private key of the board to re-sign the software package, wherein obtaining the re-signature is performed after an original signature of the software package passes a verification performed by using a software package public key of the software package, and the original signature is obtained by using a software package private key of the software package to sign the software package;
using a board public key pairing with the board private key to check the re-signature of the software package; and
booting the board after the re-signature passes the check.

2. The method according to claim 1, wherein before obtaining a re-signature of a software package to be loaded to the board, the method further comprises:
obtaining a to-be-updated software package;
using a software package public key of the to-be-updated software package to check an original signature of the to-be-updated software package in a secure world; and
after the original signature of the to-be-updated software package passes the check, re-signing the to-be-updated software package by using the board private key in the secure world.

3. The method according to claim 2, further comprising:
replacing a corresponding software package of an earlier version and a re-signature corresponding to the software package of the earlier version with the to-be-updated software package and a re-signature of the to-be-updated software package, wherein the software package of the earlier version comprises a software package public key of the earlier version.

4. The method according to claim 1, wherein the board private key is stored in a security module of a chip.

5. The method according to claim 1, further comprising:
when the board is powered on to boot, checking, by a central processing unit (CPU) on the board, by using the board public key of the board, software packages required for board bootup level by level starting from BootROM secure boot code (BSBC).

6. A method for upgrading a software package, the method comprising:
obtaining a to-be-updated software package of a board;
using a software package public key of the to-be-updated software package to check an original signature of the to-be-updated software package in a secure world; and
after the original signature of the to-be-updated software package passes the check, re-signing the to-be-updated software package by using a board private key of the board in the secure world, wherein the re-signature is used to check security of the software package when the board boots.

7. The method according to claim 6, further comprising:
replacing a corresponding software package of an earlier version and a re-signature corresponding to the software package of the earlier version with the to-be-updated software package and a re-signature of the to-be-updated software package, wherein the software package of the earlier version comprises a software package public key of the earlier version.

8. The method according to claim 6, wherein the check and the re-signing are completed at a time in a trusted environment of the secure world.

9. An apparatus for controlling secure boot of a board, the apparatus comprising:
an input/output (I/O) device;
a memory comprising instructions; and
a processor is configured to:
after the board is powered on, obtain a re-signature of a software package to be loaded to the board, wherein the re-signature of the software package is obtained by using a board private key of the board to re-sign the software package, the re-signature is obtained after an original signature of the software package passes a verification performed by using a software package public key of the software package, and the original signature is obtained by using a software package private key of the software package to sign the software package,
use a board public key pairing with the board private key to check the re-signature of the software package, and
boot the board after the re-signature passes the check.

10. The apparatus according to claim 9, wherein before obtaining a re-signature of a software package to be loaded to the board, the processor is further configured to:
obtain a to-be-updated software package;
use a software package public key of the to-be-updated software package to check an original signature of the to-be-updated software package in a secure world; and
after the original signature of the to-be-updated software package passes the check, re-sign the to-be-updated software package by using the board private key in the secure world.

11. The apparatus according to claim 10, wherein the processor is further configured to:
replace a corresponding software package of an earlier version and a re-signature corresponding to the software package of the earlier version with the to-be-updated software package and a re-signature of the to-be-updated software package, wherein the software package of the earlier version comprises a software package public key of the earlier version.

12. The apparatus according to claim 9, wherein the board private key is stored in a security module of a chip.
